(19) United States
(12) Patent Application Publication
(10) Pub. No.: US 2022/0298730 A1
(43) Pub. Date: Sep. 22, 2022

(54) AUTOMATED SPRAY SYSTEM FOR A MILLING MACHINE

(71) Applicant: Caterpillar Paving Products Inc., Brooklyn Park, MN (US)

(72) Inventor: Brian Joe SCHLENKER, Shoreview, MN (US)

(73) Assignee: Caterpillar Paving Products Inc., Brooklyn Park, MN (US)

(21) Appl. No.: 17/202,621

(22) Filed: Mar. 16, 2021

(51) Int. Cl. E01C 19/17; E01C 23/088

(52) U.S. Cl. CPC E01C 19/176; E01C 23/088

(57) ABSTRACT

A spray system for a milling machine includes a plurality of flow adjustment assemblies, which include a flow adjustment assembly, and a spray controller. The flow adjustment assembly includes a pressure sensor and a valve. The spray controller is configured to receive, from a user interface, an input that indicates a desired flow rate of a fluid through the flow adjustment assembly. The spray controller is configured to receive, from the pressure sensor, a pressure measurement of the fluid. The spray controller is configured to determine, based on receiving the pressure measurement, a desired opening size of the valve to enable the desired flow rate of the fluid. The spray controller is configured to actuate the valve to adjust an opening size of the valve to equal the desired opening size and cause the fluid to flow through the flow adjustment assembly at the desired flow rate.

### TECHNICAL FIELD

The present disclosure relates generally to a spray system and, for example, to an automated spray system for a milling machine.

### BACKGROUND

A milling machine, such as a rotary mixer or a cold planer, includes a rotor and a spray system. During a ground-working operation, the rotor is used to break up a substrate (e.g., asphalt, soil, and/or a combination thereof) as the spray system dispenses fluid. Depending on the application, the spray system may dispense different types of fluid and/or have a different arrangement of components. For example, in a rotary mixer, which may be used for ground-working operations such as road reclamation, soil stabilization, surface mining, and/or bio-remediation, the spray system typically utilizes one or more spray banks, each having a plurality of outlets, to spray water and/or emulsion into a mixing chamber that houses the rotor. The water may be used to cool the rotor, reduce dust, mix with dry additives (e.g., fly ash, portland cement, and/or lime) during soil stabilization, and/or the like. The emulsion, on the other hand, may be used to mix with reclaimed material during road reclamation. As another example, in a cold planer, which may be used for ground-working operations such as surface mining and/or plunge-cut operations, the spray system typically utilizes a plurality of water-dispensing spray banks that are arranged to cool the rotor and reduce dust along one or more conveyors.

However, depending on the application and/or position of the machine during operation, an operator of the machine may wish to adjust a flow rate of the fluid at one or more outlets of the spray system. Current milling machines require the operator to make such an adjustment based, for example, on visual inspection of the fluid during operation, which may be difficult and/or yield inconsistent results. Furthermore, in some situations, the spray system may experience obstructions, which may be difficult to detect and lead to significant damage.

CN110306406(A) discloses a device and method for controlling transverse uniformity of a liquid. The device comprises a spraying rod, at least two spraying assemblies and a controller. The spraying rod is a hollow structure and is used for receiving the liquid. Each spraying assembly comprises a nozzle, a spraying valve and a pressure sensor. The spraying valves are used for controlling the communication state between the inlets of the nozzles and the interiors of the spraying rods. The pressure sensors are used for detecting a pressure value at the inlets of the nozzles. The controller is used for controlling a duty ratio of the spraying valves according to received pressure signal values sent by all the pressure sensors and built-in liquid total flow value, and controlling the closing and opening the spraying valves on the basis of the duty ratio.

The spray system of the present disclosure solves one or more of the problems set forth above and/or other problems in the art.

### SUMMARY

In some implementations, a spray system for a milling machine includes a plurality of flow adjustment assemblies, wherein a particular flow adjustment assembly, of the plurality of flow adjustment assemblies, includes a pressure sensor and a valve; and a spray controller that interacts with the plurality of flow adjustment assemblies and is configured to: receive, from a user interface, an input that indicates a desired flow rate of a fluid through the particular flow adjustment assembly, receive, from the pressure sensor of the particular flow adjustment assembly, a pressure measurement of the fluid, determine, based on receiving the pressure measurement, a desired opening size of the valve of the particular flow adjustment assembly to enable the desired flow rate of the fluid, and actuate, based on determining the desired opening size of the valve, the valve to adjust an opening size of the valve to equal the desired opening size and cause the fluid to flow through the particular flow adjustment assembly at the desired flow rate.

In some implementations, a milling machine includes a plurality of fluid outlets that are configured to dispense fluid; a corresponding plurality of flow adjustment assemblies that are configured to enable variable flow rates of the fluid through the plurality of fluid outlets, wherein a particular flow adjustment assembly, of the plurality of flow adjustment assemblies, includes a pressure sensor and a valve; and a spray controller that interacts with the plurality of flow adjustment assemblies and is configured to: receive, from a user interface, an input that indicates a desired flow rate of the fluid through the particular flow adjustment assembly, receive, from the pressure sensor of the particular flow adjustment assembly, a pressure measurement of the fluid, determine, based on receiving the pressure measurement, a desired opening size of the valve of the flow adjustment assembly to enable the desired flow rate of the fluid, and actuate, based on determining the desired opening size of the valve, the valve to adjust an opening size of the valve to equal the desired opening size and cause the fluid to flow through the flow adjustment assembly at the desired flow rate.

In some implementations, a method includes receiving, from a user interface, an input that indicates a desired flow rate of a fluid through a particular flow adjustment assembly of a plurality of flow adjustment assemblies, wherein the particular flow adjustment assembly includes a sensor and a valve; receiving, from the sensor of the particular flow adjustment assembly, a measurement of the fluid; determining, based on receiving the measurement, a desired opening size of the valve of the particular flow adjustment assembly to enable the desired flow rate of the fluid; and actuating, based on determining the desired opening size of the valve, the valve to adjust an opening size of the valve to equal the desired opening size and cause the fluid to flow through the particular flow adjustment assembly at the desired flow rate.

### BRIEF DESCRIPTION OF THE DRAWINGS

FIG. 1 is a side view of an example machine described herein.

FIG. 2 is a diagram of an example spray system of the machine.

FIG. 3 is a side view of an example flow adjustment assembly of the spray system.

FIG. 4 is a side view of an example flow adjustment assembly of the spray system.

FIG. 5 is a flowchart of an example method associated with the spray system.

### DETAILED DESCRIPTION

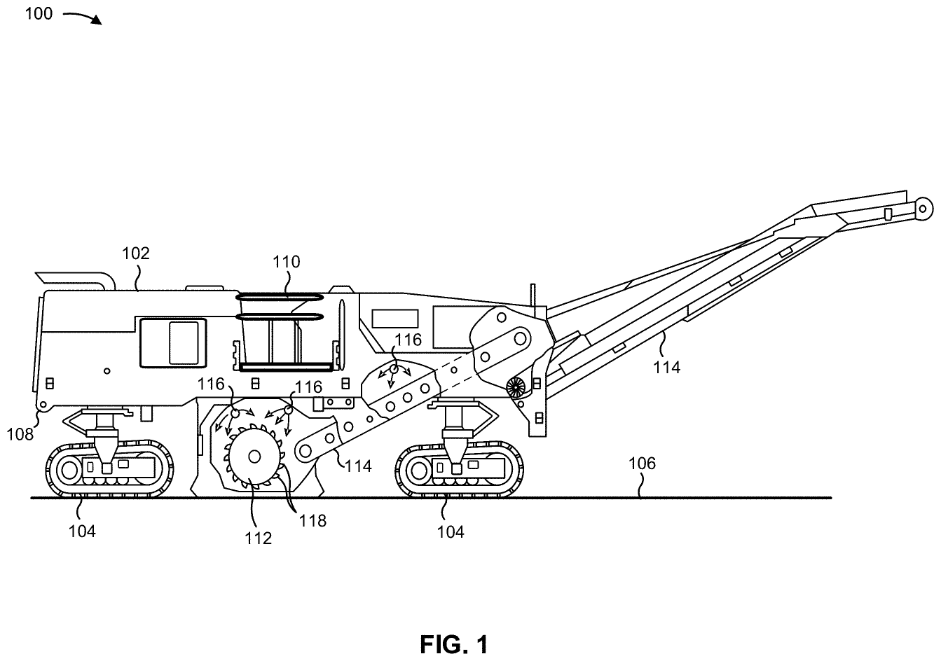

This disclosure relates to a spray system, which is applicable to any machine that dispenses fluids. While a milling machine in the form of a cold planer is illustrated in FIG. 1, other types of machines are contemplated (e.g., a rotary mixer, an autonomous machine, a pushed machine, a towed machine, and/or another type of machine).

To simplify the explanation below, the same reference numbers may be used to denote like features. The drawings may not be to scale.

FIG. 1 depicts an example machine 100. The machine 100 includes a machine body 102 and a plurality of ground-engaging members 104 that support the machine body 102. The ground-engaging members, which may include track-type members (as shown) or wheels, are configured to engage a ground surface 106 and move the machine body 102 therealong. Although only two ground-engaging members 104 are depicted in FIG. 1, it should be understood that the machine 100 includes two additional ground-engaging members on an opposite side of the machine body 102. Different types and/or arrangements of ground-engaging members are herein contemplated.

The machine body 102 includes a frame 108, an operator station 110, a rotor 112, a pair of conveyors 114, and a plurality of spray banks 116. The frame 108 is a structure that supports and encloses, at least in part, the operator station 110, the rotor 112, the pair of conveyors 114, and the plurality of spray banks 116. The operator station 110 is a compartment for an operator of the machine 100. The operator station 110 may include input devices for the operator to control the ground-engaging members 104, the rotor 112, the pair of conveyors 114, and/or the spray banks 116. The rotor 112 is a device that is configured to rotate within the frame 108 to break up the ground surface 106 during a ground-working operation (e.g., a surface mining operation, a plunge-cut operation, and/or the like). For example, the rotor 112, which may include a plurality of teeth 118 to penetrate the ground surface 106, may be a universal rotor, a combination rotor, a soil rotor, a spade rotor, or another type of rotor. The pair of conveyors 114 are configured to transport debris generated by the rotor (e.g., asphalt debris, soil debris, and/or a combination thereof) to a second machine, such as a dump truck (not shown), for disposal of the debris.

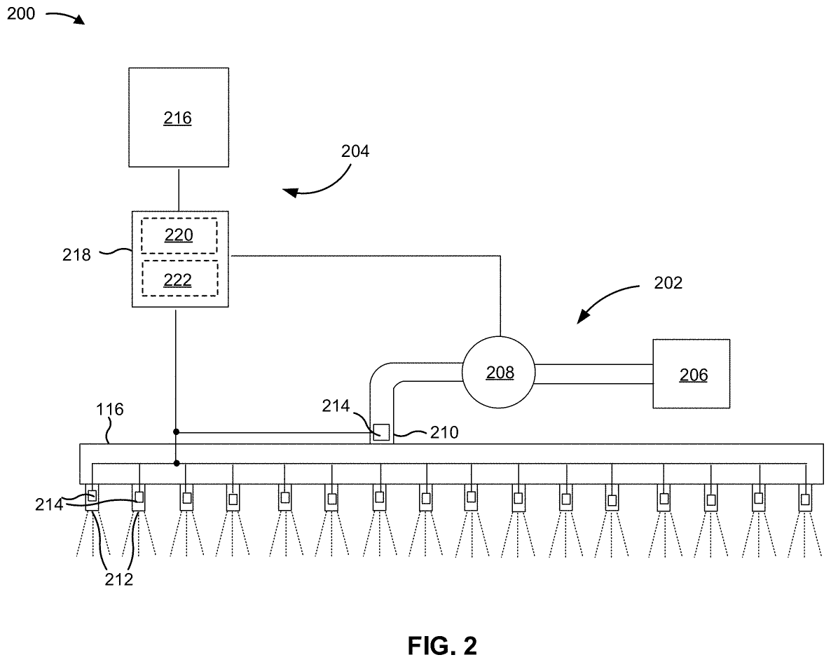

The plurality of spray banks 116, which will be described below in connection with FIGS. 2-4, are configured to dispense fluid during operation of the machine 100 to cool one or more machine components (e.g., the rotor and/or at least one of the pair of conveyors 114) and/or reduce dust relating to the debris. While the plurality of spray banks 116, as shown, are configured to dispense water at the rotor 112 and at least one of the pair of conveyors 114, other spray bank arrangements and/or types of fluids are contemplated. For example, in a ground-working operation such as road reclamation, one or more spray banks 116 may dispense emulsion at the ground surface 106. As a further example, in a ground-working operation such as soil stabilization, one or more spray banks 116 may dispense water at the ground surface 106.

As indicated above, FIG. 1 is provided as an example. Other examples may differ from what is described with regard to FIG. 1. For example, the number and arrangement of components (e.g., the ground-engaging member 104, the frame 108, the operator station 110, the rotor 112, the pair of conveyors 114, the plurality of spray banks 116, the plurality of teeth 118) may differ from that shown in FIG. 1. Thus, there may be additional components, fewer components, different components, differently shaped components, differently sized components, and/or differently arranged components than those shown in FIG. 1. For example, the machine 100 may include a different number of spray banks (e.g., one spray bank, two spray banks, four spray banks).

FIG. 2 depicts an example spray system 200 of the machine 100. To simplify explanation, the spray system 200 is depicted as having a single spray bank 116 (hereinafter referred to as the spray bank 116) of the plurality of spray banks 116. However, it should be understood that the functionality of the spray system 200, in relation to the spray bank 116, applies to all of the plurality of spray banks 116.

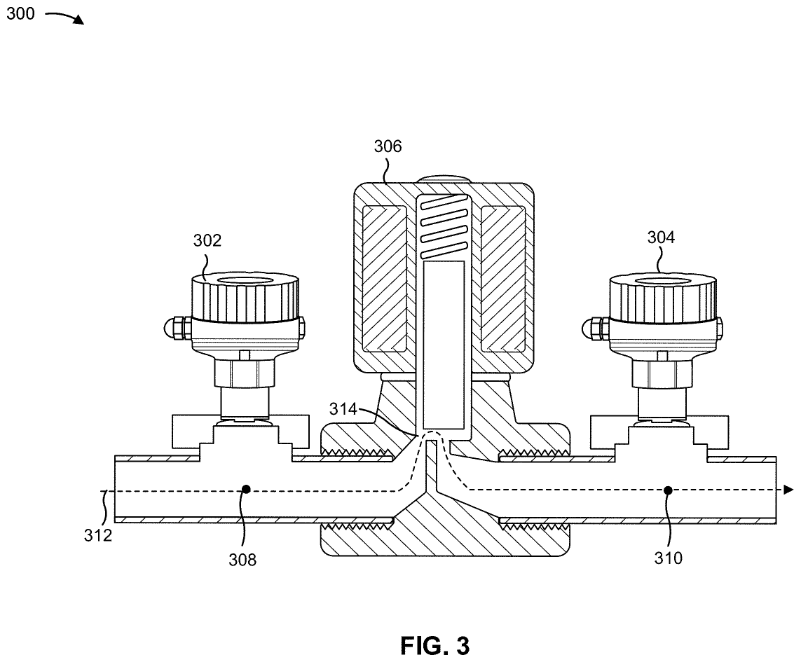

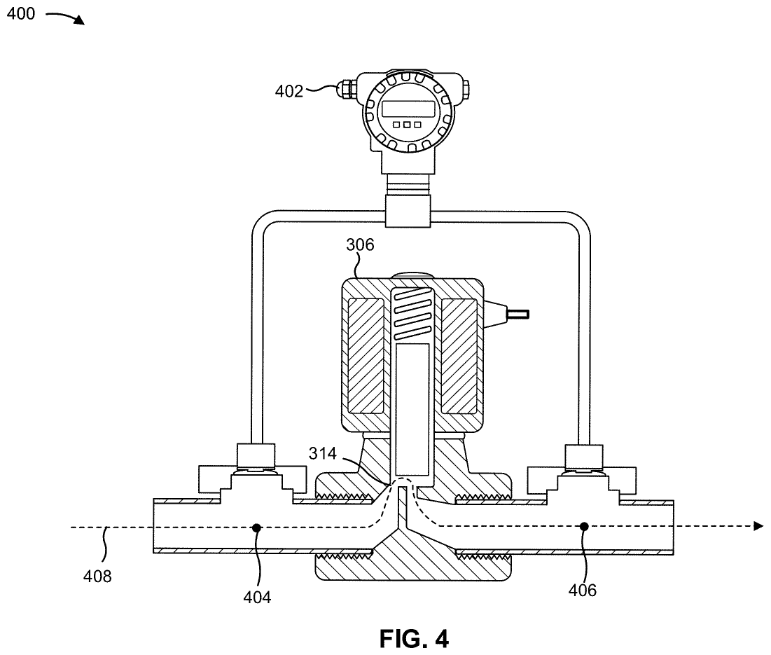

The spray system 200 includes fluid circulation system 202 and an electronic control system 204 that communicates with the fluid circulation system 202. The fluid circulation system 202 includes a fluid source 206, the spray bank 116, and a pump 208 fluidly connected therebetween. The fluid source 206 is configured to store the fluid (e.g., water or emulsion) therein. For example, the fluid source 206 may be a retention tank. The spray bank 116, as indicated above, is configured to disperse the fluid. The spray bank 116 includes an inlet 210, a plurality of outlets 212, and a plurality of flow adjustment assemblies 214 (variations of which will be described below in connection with FIGS. 3-4). A flow adjustment assembly 214, of the plurality of flow adjustment assemblies 214, is located at each of the inlet 210 and the plurality of outlets 212 to enable flow rate adjustment of the fluid traveling through the inlet 210 and/or one or more of the plurality of outlets 212. The pump 208 is configured to pressurize and deliver the fluid from the fluid source 206 into the inlet 210 of the spray bank 116.

The electronic control system 204, which is configured to interact with the fluid circulation system 202, includes a user interface 216 and a spray controller 218. The user interface 216, which may be one of the input devices in the operator station 110, is a device that is configured to receive, from the operator, input that indicates actuation of the pump 208 and/or one more values relating to flow of the fluid (e.g., a desired flow rate of the fluid through a particular flow adjustment assembly 214) and transmit the input to the spray controller 218. For example, the user interface 216 may include a keyboard, a keypad, a touch screen, a mouse, a track-pad, a trackball, one or more push-buttons, one or more toggle switches, a voice recognition system, or another type of input device.

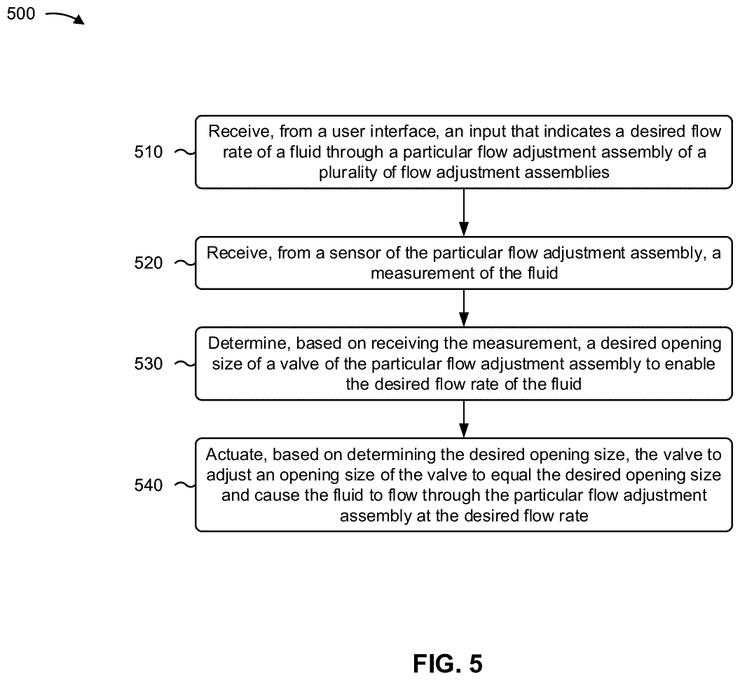

The spray controller 218 is a device that is configured to interact with the pump 208 and the plurality of flow adjustment assemblies 214 to actuate flow of the fluid and/or adjust a flow rate of the fluid based on receiving the input from the user interface 216. The spray controller 218 includes a processor 220 and a memory 222. The processor 220 is implemented in hardware, firmware, and/or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 220 includes one or more processors capable of being programmed to perform a function. The memory 222 includes a random-access memory (RAM), a read only memory (ROM), and/or another type of dynamic or static storage device (e.g., a flash memory, a magnetic memory, and/or an optical memory) that stores information and/or instructions for use by the processor 220 (e.g., information and/or instructions associated with flow of the fluid). Based on communication with the user interface 216 and one or more of the flow adjustment assemblies 214 (a process which will be described below in connection with FIG. 5), the spray controller 218 is configured to cause the spray bank 116 to dispense the fluid through the plurality of outlets 212 at desired flow rates. Depending on the type of ground-working operation, environmental conditions, and/or orientation of the machine 100, the desired flow rates may include different flow rates (e.g., a higher or lower flow rate at one outlet of the spray bank than another outlet of the spray bank), relatively increased or decreased flow rates (e.g., due to adjustment of a flow rate at the inlet), flow rates that are equal to or differ from flow rates within other spray banks 116, and/or the like.

As indicated above, FIG. 2 is provided as an example. Other examples may differ from what is described with regard to FIG. 2. For example, the number and arrangement of components (e.g., the fluid source 206, the spray bank 116, the pump 208, the inlet 210, the plurality of outlets 212, the plurality of flow adjustment assemblies 214, the user interface 216, and/or the spray controller 218) may differ from that shown in FIG. 2. Thus, there may be additional components, fewer components, different components, differently shaped components, differently sized components, and/or differently arranged components than those shown in FIG. 2. For example, the spray bank 116 may include a different number of inlets, a different number of outlets, and/or a different number of flow adjustment assemblies.

FIGS. 3-4 respectively depict an example flow adjustment assembly 300 and an example flow adjustment assembly 400, which represent variants of the flow adjustment assembly 214. While the flow adjustment assembly 300 and the flow adjustment assembly 400 are respectively shown as being provided on a single outlet 212 of the spray bank 116 (hereinafter referred to as the outlet 212), it should be understood that the flow adjustment assembly 300 may be provided at every adjustment location of the spray bank 116 (e.g., the inlet 210 and the plurality of outlets 212), the flow adjustment assembly 400 may be provided at every adjustment location of the spray bank 116, or the flow adjustment assembly 300 and the flow adjustment assembly 400 may be each be provided at a complementary subset of adjustment locations of the spray bank 116. In other words, the spray bank 116 may include only flow adjustment assemblies 300, only flow adjustment assemblies 400, or a combination of the flow adjustment assemblies 300 and the flow adjustment assemblies 400.

As shown in FIG. 3, the flow adjustment assembly 300 includes a first pressure sensor 302, a second pressure sensor 304, and a valve 306 arranged therebetween. The first pressure sensor 302 and the second pressure sensor 304 are devices that are configured to determine pressure measurements of the fluid at respective locations 308 and 310 along a flow path 312 and communicate such pressure measurements to the spray controller 218. For example, the first pressure sensor 302 and the second pressure sensor 304 may be gauge pressure sensors, and the pressure measurements may be gauge pressure values. In use, the first pressure sensor 302 and the second pressure sensor 304 may transmit the pressure measurements to the spray controller 218 based on a request from the spray controller 218, based on a transmission schedule, and/or the like. The valve 306 is a device that is configured to adjust an opening size of an internal opening 314 along the flow path 312. For example, the valve 306 may be an electronic valve, such as a solenoid valve, a ball valve, a butterfly valve, or another type of valve. In use, the valve 306 may adjust the opening size of the internal opening 314 based receiving on an instruction from the spray controller 218, as will be described below in connection with FIG. 5.

As shown in FIG. 4, the flow adjustment assembly 400 includes a pressure sensor 402 and the valve 306 arranged adjacently thereto. The pressure sensor 402 is a device that is configured to determine a pressure measurement of the fluid associated with locations 404 and 406 along a flow path 408 and communicate such pressure measurement to the spray controller 218. For example, the pressure sensor 402 may be differential pressure sensor, and the pressure measurement may be a differential pressure value (e.g., a difference between a pressure value the location 404 of the flow path 408 and a pressure value at the location 406 of the flow path 408). In use, the pressure sensor 402 may transmit the pressure measurement to the spray controller 218 based on a request from the spray controller 218, based on a transmission schedule, and/or the like. The valve 306 has the same structure and functionality as described above in connection with FIG. 3.

As indicated above, FIGS. 3-4 are provided as examples. Other examples may differ from what is described with regard to FIGS. 3-4. For example, there may be different types of pressure sensors and/or different types of valves.

FIG. 5 is a flowchart of an example method 500 associated with the spray system 200. It should be understood that one or more method blocks of FIG. 5 may be performed by the spray controller 218.

As shown in FIG. 5, method 500 may include receiving, from a user interface, an input that indicates a desired flow rate of a fluid through a particular flow adjustment assembly of a plurality of flow adjustment assemblies, wherein the particular flow adjustment assembly includes a sensor and a valve (block 510). For example, the spray controller 218 may receive, from the user interface 216, an input that indicates a desired flow rate of the fluid through a particular flow adjustment assembly 214 of a plurality of flow adjustment assemblies 214. Prior to receiving the input that indicates the desired flow rate, the spray controller 218 may receive, from the user interface 216 an input that indicates actuation of the pump 208. Based on receiving the input that indicates actuation of the pump 208, the spray controller 218 may actuate the pump 208, thereby causing the pump 208 to pressurize and deliver the fluid from the fluid source 206 into the inlet 210 of the spray bank 116.

As further shown in FIG. 5, method 500 may include receiving, from a sensor of the particular flow adjustment assembly, a measurement of the fluid (block 520). For example, the spray controller 218 may receive, from the first pressure sensor 302 or the pressure sensor 402 of the particular flow adjustment assembly 214, a measurement of the fluid. As indicated above, the first pressure sensor 302 may be a gauge pressure sensor, and the pressure sensor 402 may be a differential pressure sensor. The measurement may be a pressure measurement, such a gauge pressure value or a differential pressure value. Prior to receiving the measurement and based on receiving the input that indicates the desired flow rate, method 500 may further include providing, to the sensor of the particular flow adjustment assembly, a request for a measurement of the fluid. In such a case, receiving the measurement from the sensor may be based on providing the request to the sensor. For example, the spray controller 218, prior to receiving the measurement and based on receiving the input that indicates the desired flow rate, may provide a request for the measurement to the first pressure sensor 302 or the pressure sensor 402. The spray controller 218 may thereafter receive the measurement from the first pressure sensor 302 or the pressure sensor 402 based on providing the request. When the sensor is the first pressure sensor 302, method 500 may further include receiving, from a second sensor of the particular flow adjustment assembly, a second measurement of the fluid. For example, the spray controller 218 may receive, from the second pressure sensor 304, a second pressure measurement of the fluid (e.g., a second gauge pressure value).

As further shown in FIG. 5, method 500 may include determining, based on receiving the measurement, a desired opening size of a valve of the particular flow adjustment assembly to enable the desired flow rate of the fluid (block 530). For example, the spray controller 218 may determine, based on receiving the measurement, a desired opening size of the valve 306 of the particular flow adjustment assembly 214 to enable the desired flow rate of the fluid. The desired opening size may be, for example, a desired diameter. The spray controller 218 may determine the desired opening size based on, for example, Poiseuille law, which defines a mathematical relationship between a flow rate of a fluid, a diameter of a flow path of the fluid, a change in pressure of the fluid along the flow path, and a viscosity of the fluid. In such an example, the spray controller 218 may determine the desired opening size of the valve 306 based on the measurement (e.g., a gauge pressure value or a differential pressure value) of the fluid, the desired flow rate of the fluid, and a viscosity value of the fluid. In some implementations, determining the desired opening size may be further based on receiving the second measurement.

As further shown in FIG. 5, method 500 may include actuating, based on determining the desired opening size of the valve, the valve to adjust an opening size of the valve to equal the desired opening size and cause the fluid to flow through the particular flow adjustment assembly at the desired flow rate (block 540). For example, the spray controller 218 may actuate, based on determining the desired opening size of the valve 306, the valve 306 to adjust an opening size of the valve 306 to equal the desired opening size and cause the fluid to flow through the particular flow adjustment assembly 214 at the desired flow rate. The opening size may be a diameter.

It should be understood that one or more of the above-described steps of the method 500 (e.g., block 510, 520, 530, and/or block 540) may be repeated in relation to different flow adjustment assemblies 214 of the plurality of flow adjustment assemblies 214. In other words, the method 500 may be an iterative process and involve continued communication with the sensors and adjustment of the valves to produce the desired flow rates of the fluid (e.g., in accordance with Bernoulli principles).

Although FIG. 5 shows example blocks of method 500, in some implementations, method 500 may include additional blocks, fewer blocks, different blocks, or differently arranged blocks than those depicted in FIG. 5. Additionally, or alternatively, two or more of the blocks of method 500 may be performed in parallel.

### INDUSTRIAL APPLICABILITY

The spray system 200, as described here, is particularly applicable to a machine that dispenses fluids in association with working material of a substrate (e.g., asphalt, aggregate, soil, and/or a combination thereof). For example, the machine 100 may be a milling machine (e.g., a cold planer, a rotary mixer) or another type of machine.

By utilizing a plurality of flow adjustment assemblies 214, which each include one or more pressure sensors (e.g., a pair of gauge pressure sensors and/or a differential pressure sensor) and a valve (e.g., the valve 306), the spray system 200 enables automated adjustment of flow rates of the fluid at one or more of the plurality of outlets 212. As a result, the spray system 200 may facilitate the adjustment process for an operator of the machine 100 and yield more consistent results. This type of automated adjustment process may be especially beneficial in dusty environments, during ground-working operations that tend to over-heat components (e.g., the rotor 112 and/or the pair of conveyors 114), and/or when the machine 100 is positioned at an incline. Furthermore, by including the plurality of flow adjustment assemblies 214, the spray system 200 has an added capability of detecting obstructions within the fluid circulation system 202, which may prevent component damage and, as a result, conserve resources that might otherwise have been consumed replacing and/or repairing the damaged components.

What is claimed is:

1. A spray system for a milling machine, comprising:
a plurality of flow adjustment assemblies,
wherein a particular flow adjustment assembly, of the plurality of flow adjustment assemblies, includes a pressure sensor and a valve; and
a spray controller that interacts with the plurality of flow adjustment assemblies and is configured to:
receive, from a user interface, an input that indicates a desired flow rate of a fluid through the particular flow adjustment assembly,
receive, from the pressure sensor of the particular flow adjustment assembly, a pressure measurement of the fluid,
determine, based on receiving the pressure measurement, a desired opening size of the valve of the particular flow adjustment assembly to enable the desired flow rate of the fluid, and
actuate, based on determining the desired opening size of the valve, the valve to adjust an opening size of the valve to equal the desired opening size and cause the fluid to flow through the particular flow adjustment assembly at the desired flow rate.

2. The spray system of claim 1, further comprising:
one or more spray banks,
wherein the one or more spray banks each include a fluid inlet and a plurality of fluid outlets,
wherein the fluid inlet and the plurality of fluid outlets each include a respective flow adjustment assembly of the plurality of flow adjustment assemblies.

3. The spray system of claim 2, wherein
the one or more spray banks include a plurality of spray banks; and
the particular flow adjustment assembly of the plurality of flow adjustment assemblies is located at the fluid inlet of a spray bank of the plurality of spray banks.

4. The spray system of claim 2, wherein the particular flow adjustment assembly of the plurality of flow adjustment assemblies is located at a fluid outlet of the plurality of fluid outlets of a spray bank of the one or more spray banks.

5. The spray system of claim 3, wherein
the particular flow adjustment assembly is a first flow adjustment assembly, the pressure sensor is a first pressure sensor, the valve is a first valve, the input is a first input, the desired flow rate is a first desired flow rate, the pressure measurement is a first pressure measurement, the desired opening size is a first desired opening size, and the opening size is a first opening size;
the plurality of flow adjustment assemblies further includes a second flow adjustment assembly that includes a second pressure sensor and a second valve; and
the spray controller is further configured to:
receive, from the user interface, a second input that indicates a second desired flow rate of the fluid through the second flow adjustment assembly of the plurality of flow adjustment assemblies,
receive, from the second pressure sensor of the second flow adjustment assembly, a second pressure measurement of the fluid,
determine, based on receiving the second pressure measurement, a second desired opening size of the second valve of the second flow adjustment assembly to enable the second desired flow rate of the fluid, and
actuate, based on determining the second desired opening size of the second valve, the second valve to adjust a second opening size of the second valve to equal the second desired opening size and cause the fluid to flow through the second flow adjustment assembly at the second desired flow rate.

6. The spray system of claim 1, wherein
the pressure sensor is a differential pressure sensor; and
the pressure measurement is a differential pressure value.

7. The spray system of claim 1, wherein
the pressure sensor is a first gauge pressure sensor, the particular flow adjustment assembly further includes a second gauge pressure sensor, and the pressure measurement is a first gauge pressure value;
the spray controller, prior to determining the desired opening size of the valve, is further configured to receive, from the second gauge pressure sensor of the particular flow adjustment assembly, a second gauge pressure value of the fluid; and
determining the desired opening size of the valve is further based on receiving the second gauge pressure value.

8. A milling machine, comprising:
a plurality of fluid outlets that are configured to dispense fluid;
a corresponding plurality of flow adjustment assemblies that are configured to enable variable flow rates of the fluid through the plurality of fluid outlets,
wherein a particular flow adjustment assembly, of the plurality of flow adjustment assemblies, includes a pressure sensor and a valve; and
a spray controller that interacts with the plurality of flow adjustment assemblies and is configured to:
receive, from a user interface, an input that indicates a desired flow rate of the fluid through the particular flow adjustment assembly,
receive, from the pressure sensor of the particular flow adjustment assembly, a pressure measurement of the fluid,
determine, based on receiving the pressure measurement, a desired opening size of the valve of the flow adjustment assembly to enable the desired flow rate of the fluid, and
actuate, based on determining the desired opening size of the valve, the valve to adjust an opening size of the valve to equal the desired opening size and cause the fluid to flow through the flow adjustment assembly at the desired flow rate.

9. The milling machine of claim 8, wherein
the milling machine further comprises a rotor that is configured to plane a road surface during operation of the milling machine; and
one or more of the plurality of fluid outlets are configured to spray the fluid at the rotor.

10. The milling machine of claim 8, wherein
the milling machine further comprises one or more conveyors to transport road material out of the milling machine during operation of the milling machine; and
one or more of the plurality of fluid outlets are configured to spray the fluid at the one or more conveyors.

11. The milling machine of claim 8, wherein one or more of the plurality of fluid outlets are configured to spray the fluid at a ground surface during operation of the milling machine.

12. The milling machine of claim 8, wherein
the particular flow adjustment assembly is a first flow adjustment assembly, the pressure sensor is a first pressure sensor, the valve is a first valve, the input is a first input, the desired flow rate is a first desired flow rate, the pressure measurement is a first pressure measurement, the desired opening size is a first desired opening size, and the opening size is a first opening size;
the plurality of flow adjustment assemblies further includes a second flow adjustment assembly that includes a second pressure sensor and a second valve; and
the spray controller is further configured to:
receive, from the user interface, a second input that indicates a second desired flow rate of the fluid through the second flow adjustment assembly of the plurality of flow adjustment assemblies,
receive, from the second pressure sensor of the second flow adjustment assembly, a second pressure measurement of the fluid,
determine, based on receiving the second pressure measurement, a second desired opening size of the second valve of the second flow adjustment assembly to enable the second desired flow rate of the fluid, and
actuate, based on determining the second desired opening size of the second valve, the second valve to adjust a second opening size of the second valve to equal the second desired opening size and cause the fluid to flow through the second flow adjustment assembly at the second desired flow rate.

13. The milling machine of claim 8, wherein the fluid is water or emulsion.

14. The milling machine of claim 8, wherein determining the desired opening size is further based on the desired flow rate and a viscosity value of the fluid.

15. A method, comprising:
receiving, from a user interface, an input that indicates a desired flow rate of a fluid through a particular flow adjustment assembly of a plurality of flow adjustment assemblies,
wherein the particular flow adjustment assembly includes a sensor and a valve;
receiving, from the sensor of the particular flow adjustment assembly, a measurement of the fluid;
determining, based on receiving the measurement, a desired opening size of the valve of the particular flow adjustment assembly to enable the desired flow rate of the fluid; and
actuating, based on determining the desired opening size of the valve, the valve to adjust an opening size of the valve to equal the desired opening size and cause the fluid to flow through the particular flow adjustment assembly at the desired flow rate.

16. The method of claim 15, wherein
the sensor is a first gauge pressure sensor;
the measurement is a first pressure value;
the particular flow adjustment assembly further includes a second gauge pressure sensor;
the method further comprises receiving, from the second gauge pressure sensor of the particular flow adjustment assembly, a second pressure value of the fluid; and
determining the desired opening size is further based on receiving the second pressure value.

17. The method of claim 15, wherein
the sensor is a first differential pressure sensor; and
the measurement is a differential pressure value.

18. The method of claim 15, wherein
prior to receiving the measurement, the method includes:
providing, to the sensor of the particular flow adjustment assembly, and based on receiving the input, a request for a measurement of the fluid; and
receiving the measurement from the sensor is based on providing the request to the sensor.

19. The method of claim 15, wherein
the particular flow adjustment assembly is a first flow adjustment assembly, the sensor is a first pressure sensor, the valve is a first valve, the input is a first input, the desired flow rate is a first desired flow rate, the measurement is a first pressure measurement, the desired opening size is a first desired opening size, and the opening size is a first opening size; and
the method further comprises:
receiving, from the user interface, a second input that indicates a second desired flow rate of the fluid through a second flow adjustment assembly of the plurality of flow adjustment assemblies,
wherein the second flow adjustment assembly includes a second pressure sensor and a second valve;
receiving, from the second pressure sensor of the second flow adjustment assembly, a second pressure measurement of the fluid,
determining, based on receiving the second pressure measurement, a second desired opening size of the second valve of the second flow adjustment assembly to enable the second desired flow rate of the fluid, and
actuating, based on determining the second desired opening size of the second valve, the second valve to adjust a second opening size of the second valve to equal the second desired opening size and cause the fluid to flow through the second flow adjustment assembly at the second desired flow rate.

20. The method of claim 19, wherein the first desired flow rate is different than the second desired flow rate.
